(19) United States
(12) Patent Application Publication
(10) Pub. No.: US 2009/0024823 A1
(43) Pub. Date: Jan. 22, 2009

(54) OVERLAYED SEPARATE DMA MAPPING OF ADAPTERS

(76) Inventors: WENJENG KO, Tucson, AZ (US); Cheng-Chung Song, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/780,832

(22) Filed: Jul. 20, 2007

(51) Int. Cl. G06F 12/02

(52) U.S. Cl. 711/202; 711/E12.002

(57) ABSTRACT

DMA mapping for adapters configured to communicate with respect to a computer processor memory structure via DMA and configured to have DMA mapping space for control information and data. The adapters are separated into groups. The control information DMA mapping of the adapters is separated into at least three types: type “H” mapping, type “D” mapping, and shared mapping. The type “H” mapping and the shared mapping are applied to one group of adapters for the DMA mapping space for control information, such as host adapters, and the type “D” mapping and the shared mapping are applied to another group, such as device adapters, and the type “H” mapping of the one group and the type “D” mapping of the another group are overlayed in the DMA mapping space for control information for the respective adapters.

### CROSS REFERENCE TO RELATED APPLICATION

Commonly assigned U.S. Patent Application Serial No. (TUC920070066US2) filed on even dated herewith relates to communication systems, data storage systems and computer program products configured to provide overlayed separate DMA mapping of adapters, wherein certain types of mapping for certain groups of adapters are overlayed in the DMA mapping space for control information for the respective adapters.

### FIELD OF THE INVENTION

This invention relates to computer processor systems, and, more particularly, to communication of computer processor systems employing adapters.

### BACKGROUND OF THE INVENTION

Computer systems, such as data storage subsystems, may employ communication systems comprising adapters to interconnect with input/output resources. The adapters may employ DMA (Direct Memory Access) to communicate directly with a computer processor memory structure of the computer processor system, and thereby exchange data and control information without tying up the computer processor or processors. One example of a computer processor system is a SMP (Symmetric Multi-Processor) system in which multiple computer processors are managed to have a common computer processor memory structure. A SMP system may be employed, for example, for a data storage system.

The adapters typically access the same common control data area of the computer processor memory structure using a different memory offset for its allocated DMA memory space and each having the same layout of the DMA memory space. The allocated DMA memory space is similar in size to the memory space of the adapters used for the DMA access by the adapters. The DMA memory space of the adapters is limited, for example, to 256 MB, and so may be the DMA address space of the computer processor memory structure that can be allocated to the adapters.

The DMA address space is used for two purposes, addressing control information and data. As the request of this DMA address space grows for control information, the system has smaller space available for passing data from the adapter to the computer processor system. Smaller available address space may have the effect of slowing down the data access and may affect the system performance, for example, the transfer of data between a host system and data storage via an SMP.

### SUMMARY OF THE INVENTION

Methods, with respect to computer processors, provide DMA address mapping configured for a plurality of adapters, the adapters configured to communicate with respect to a computer processor memory structure via DMA and configured to have DMA mapping space for control information and data.

In one embodiment, the method comprises separating the plurality of adapters into at least two groups; separating control information DMA mapping of the adapters into at least three types: type “H” mapping, type “D” mapping, and shared mapping; and applying the type “H” mapping and the shared mapping to one of the groups of adapters for the DMA mapping space for control information, and applying the type “D” mapping and the shared mapping to another of the groups of adapters for the DMA mapping space for control information, and overlaying the type “H” mapping of the one group of adapters and the type “D” mapping of the another group of adapters in the DMA mapping space for control information of the respective adapters.

In a further embodiment, wherein the groups of adapters comprise at least one host adapter comprising the one group and at least one device adapter comprising the another group, and the step of applying the mapping comprises applying the type “H” mapping and the shared mapping to the at least one host adapter for the DMA mapping space, and applying the type “D” mapping and the shared mapping to the at least one device adapter for the DMA mapping space, overlaying the type “H” mapping of the at least one host adapter and the type “D” mapping of the at least one device adapter in the DMA mapping space.

In a still further embodiment, wherein the remainder of the DMA mapping space of the at least one host adapter comprises at least DMA mapping space for data.

In another embodiment, wherein the remainder of the DMA mapping space of the at least one device adapter comprises at least DMA mapping space for data.

In still another embodiment, the method for mapping DMA mapping space of a plurality of adapters of a communication system comprises initiating an IML of the communication system; separating the plurality of adapters into at least two groups; separating control information DMA mapping of the computer processor memory structure for the adapters into at least three types: type “H” mapping, type “D” mapping, and shared mapping; allocating DMA memory space of the DMA mapping space to each of the plurality of adapters; and applying the type “H” mapping and the shared mapping to one of the groups of adapters for the DMA mapping space for control information, and applying the type “D” mapping and the shared mapping to the another of the groups of adapters for the DMA mapping space for control information, and overlaying the type “H” mapping of the one of the groups of adapters and the type “D” mapping of the other of the groups of adapters in the DMA mapping space for control information of the respective adapters.

For a fuller understanding of the present invention, reference should be made to the following detailed description taken in conjunction with the accompanying drawings.

### BRIEF DESCRIPTION OF THE DRAWINGS

FIG. 1 is a block diagram of an embodiment of a data storage system in which the present invention may be implemented;

FIG. 2 is a block diagram of an embodiment of a communication system which the present invention may be implemented;

FIG. 3 is a diagrammatic illustration of a portion of a common memory structure and adapter memories configured for DMA mapping in accordance with the present invention; and

FIG. 4 is a flow chart depicting embodiments of a method and computer program product in accordance with the present invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

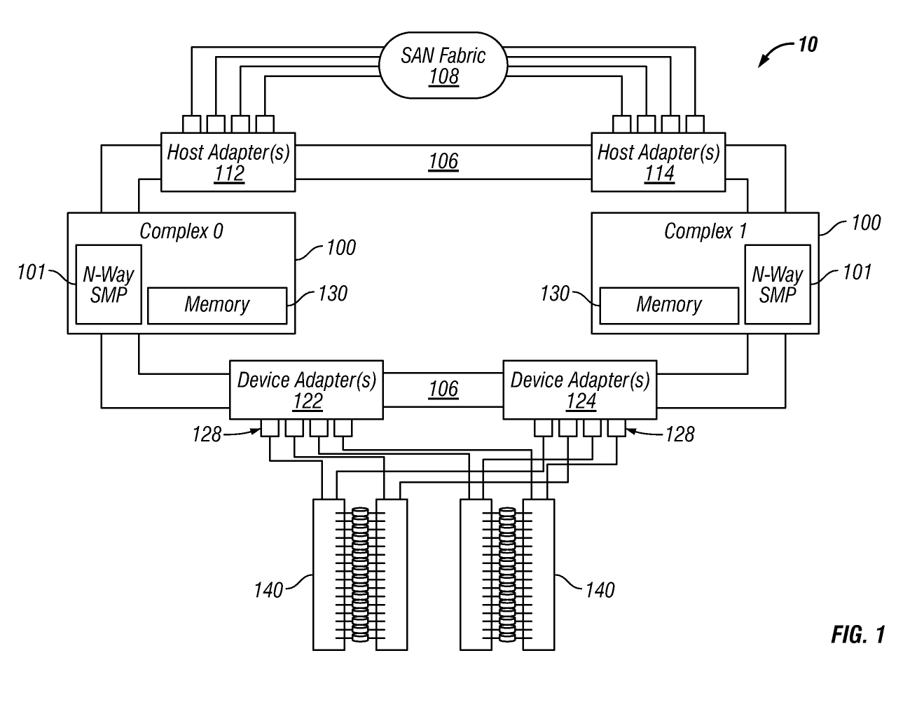

Referring to FIG. 1, a data storage system 10 may comprise redundant computer processor complexes 100, each having computer processors 101, such as a SMP (Symmetric Multi-Processor) system, and a common memory structure 130, and common input/output resources 112, 114, 122 and 124. The computer processors and input/output resources may communicate with each other and with the common memory structure by means of a common bus structure 106. In one example, the data storage system stores (including retrieval) data and information of host systems, via a storage area network (SAN Fabric) 108, in data storage devices 140. An example of data storage devices 140 comprises disk storage arrays such as redundant arrays of independent disks (RAID). Each RAID array has internal redundancies, and redundant arrays may also be provided.

The input/output resources may also be arranged for redundancy, comprising for example, first and second sets of adapters 112 and 114 respectively for communication via the storage area network, and first and second sets of adapters 122 and 124 for communication with the both sets of disk storage arrays, for example, via redundant switches 128. The adapters may employ DMA (Direct Memory Access) to communicate directly with the computer processor memory structure 130 of the computer processor system, and thereby exchange data and control information without tying up the computer processor or processors.

Examples of data storage systems comprise the IBM® DS6000 and DS8000 families of data storage systems.

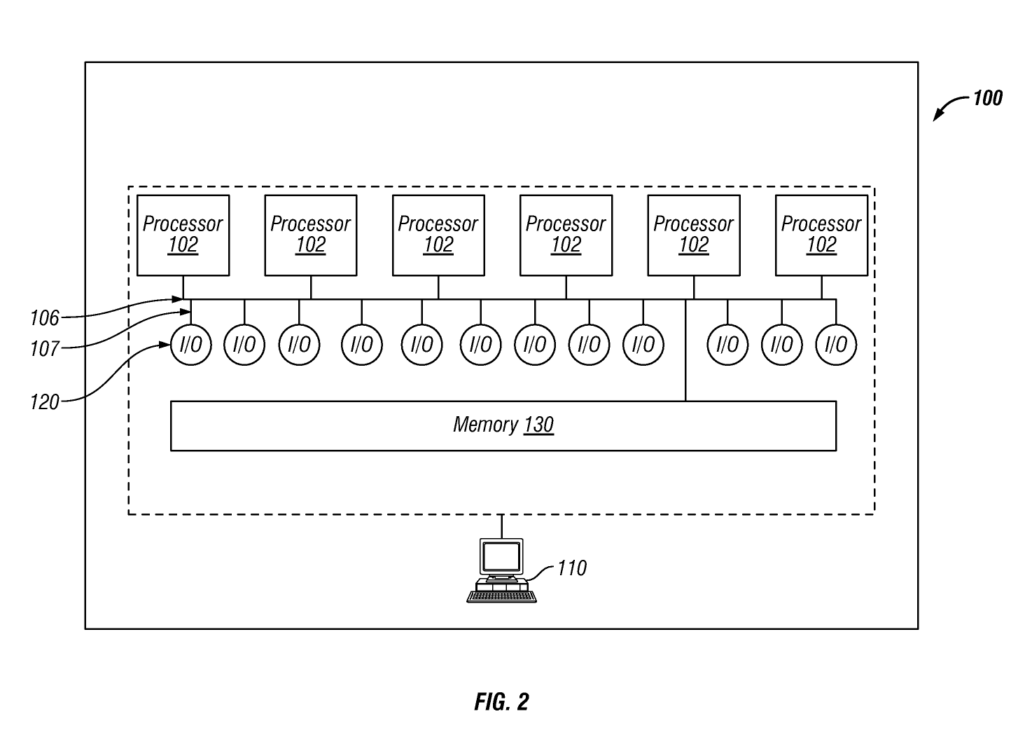

An example of a communication system which may be implemented as a computer processor complex 100 is illustrated in FIG. 2, in which the common bus structure 106 provides a direct communication path between the computer processors 102 of the complex, the input/output resources such as adapters 120 connected through adapter slots 107, and the common memory structure 130. A redundant complex may comprise each of the complexes of FIG. 1, or the processors 102 and memory 130 may be arranged to provide redundancies used as separate complexes of FIG. 1. Bus structure 106 may also be arranged to comprise a redundant bus structure.

A system administrator may interact with the system, for example, through a management console 110.

The invention can take the form of an entirely hardware embodiment, an entirely software embodiment or an embodiment containing both hardware and software elements. In a preferred embodiment, the invention is implemented in software, which includes but is not limited to resident software, microcode, firmware, etc.

Furthermore, the invention can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, and random access memory (RAM), a read-only memory (ROM), a rigid magnetic disk and an optical disk. Current examples of optical disks include compact disk-read only memory (CD-ROM), compact disk-read/write (CD-R/W), digital versatile disk (DVD) and Blu-Ray.

A computer processing system suitable for storing and/or executing program code will include at least one computer processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Connections 108 to the receiver may encompass connection links including intervening private or public networks. The communication links may comprise serial interconnections, such as RS-232 or RS-422, Ethernet connections, SCSI interconnections, ESCON interconnections, FICON interconnections, a Local Area Network (LAN), a private Wide Area Network (WAN), a public wide area network, Storage Area Network (SAN), Transmission Control Protocol/Internet Protocol (TCP/IP), the Internet, and combinations thereof.

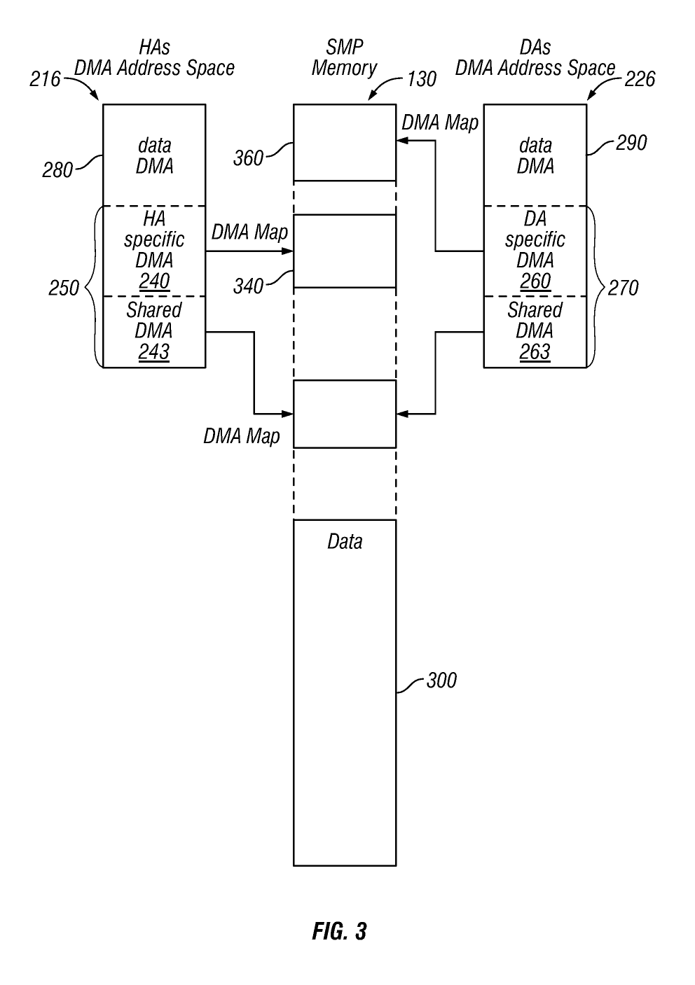

Referring additionally to FIG. 3, a portion of an SMP common memory structure 130 is illustrated together with DMA address space 216 of a host adapter 112, 114, and with DMA address space 226 of a device adapter 122, 124. The adapters 112, 114, 122, 124 are configured to communicate with respect to the common memory structure 130 and configured to have DMA mapping space 216, 226 for control information and data. The DMA mapping space for the common memory structure also is for control information and data.

The DMA mapping is separated into at least three types: type “H” mapping, type “D” mapping, and shared mapping for the control information. Herein, the term “shared” mapping means that the mapping is for control information that is generic to, or used by, each of the adapters, no matter which type.

The adapters are separated into at least two groups of adapters, host adapters 112, 114, and device adapters 122, 124. The DMA mapping space of one of the groups of adapters, host adapter 112, or host adapter 114, is configured for type “H” mapping 240 and shared mapping 243 for control information 250. The type “H” mapping is thus for host adapter specific control information, and shared mapping is generic to both the host adapters and device adapters. The DMA mapping space for another of the groups of adapters, device adapter 122, or device adapter 124, is configured for type “D” mapping 260 and shared mapping 263 for control information 270. The type “D” mapping is thus for device adapter specific control information, and shared mapping is generic to both the host adapters and device adapters. The type “H” mapping 240 of a host adapter and the type “D” mapping 260 of a device adapter are overlayed in the DMA mapping space for control information 250, 270 of the respective adapters. Thus, rather than both types of adapters having mapping for all of the control information, only host adapters have the type “H” mapping and only device adapters have the type “D” mapping.

The separation of the types of mapping and overlaying the different types of mapping thus saves DMA address space in the adapters so that more space 280, 290 is available for data handling in both groups of adapters.

The same is true of the common memory structure 130, wherein the type “H” mapping 340 of a host adapter and the type “D” mapping 360 of a device adapter are overlayed in the DMA mapping space of the common memory structure. Thus, the separation of the types of mapping and overlaying the different types of mapping saves DMA address space in the common memory structure 130 so that more space 300 is available for data handling.

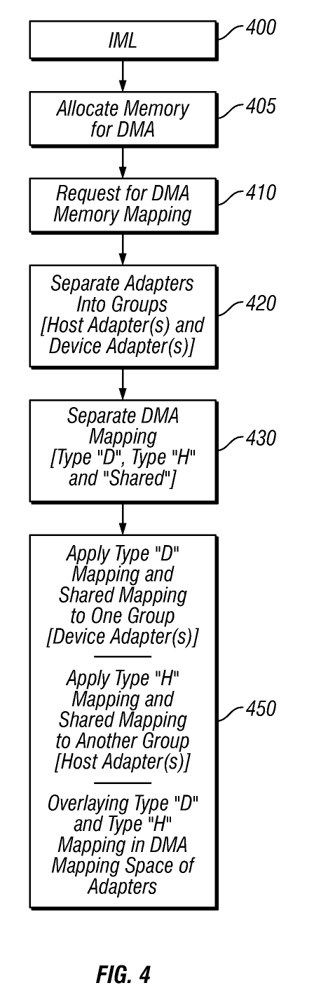

Referring additionally to FIG. 4, an embodiment of a method for mapping DMA mapping space of a plurality of adapters is illustrated. As above, the adapters are configured to communicate with respect to a computer processor memory structure 130 via DMA, the DMA mapping space comprising control information and data. Step 400 initiates an IML (Initial Microcode Load) of the system. Step 405 allocates DMA memory space for the DMA mapping space, for example, for both computer processor memory structure 130 and the respective adapter memories, to each of the respective plurality of adapters. Step 410 comprises a request for DMA memory space mapping as a step in the IML process. Step 420 separates the plurality of adapters into at least two groups, such as host adapters 112, 114, and device adapters 122, 124.

Step 430 separates the DMA mapping of the computer processor memory structure 130 for the adapters into at least three types: type “H” mapping, type “D” mapping, and shared mapping.

Step 450 applies the type “H” mapping and shared mapping to one of the groups of adapters, e.g. host adapters 112, 114, for the DMA mapping space for control information; applies the type “D” mapping and shared mapping to another of the groups of adapters, e.g. device adapters 122, 124 for the DMA mapping space for control information; and overlays the type “H” mapping of the one group of adapters and the type “D” mapping of the another group of adapters in the DMA mapping space for control information of the respective adapters, for example, for both computer processor memory structure 130 and the respective adapter memories, to each of the respective plurality of adapters.

Overlaying the control information DMA address space for the various types of adapters rather than having all of the adapters store all of the control information saves DMA address space in the adapters so that more DMA address space 280, 290 is available for data handling in both groups of adapters. Further, overlaying the control information DMA address space for the various types of adapters saves DMA address space in the common memory structure 130, wherein the type “H” mapping 340 of a host adapter and the type “D” mapping 360 of a device adapter are overlayed in the DMA mapping space of the common memory structure, allows more DMA address space 300 to be available for data handling.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A method for providing DMA mapping configured for a plurality of adapters, said adapters configured to communicate with respect to a computer processor memory structure via DMA and configured to have DMA mapping space for control information and data, comprising the steps of:
separating said plurality of adapters into at least two groups;
separating control information DMA mapping of said adapters into at least three types: type “H” mapping, type “D” mapping, and shared mapping; and
applying said type “H” mapping and said shared mapping to one of said groups of adapters for said DMA mapping space for control information, and applying said type “D” mapping and said shared mapping to another of said groups of adapters for said DMA mapping space for control information, and overlaying said type “H” mapping of said one group of adapters and said type “D” mapping of said another group of adapters in said DMA mapping space for control information of said respective adapters.

2. The method of claim 1, wherein said at least two groups of adapters comprise at least one host adapter comprising said one group and at least one device adapter comprising said another group, and said step of applying said mapping comprises applying said type “H” mapping and said shared mapping to said at least one host adapter for said DMA mapping space, and applying said type “D” mapping and said shared mapping to said at least one device adapter for said DMA mapping space, overlaying said type “H” mapping of said at least one host adapter and said type “D” mapping of said at least one device adapter in said DMA mapping space.

3. The method of claim 2, wherein the remainder of said DMA mapping space of said at least one host adapter comprises at least DMA mapping space for data.

4. The method of claim 2, wherein the remainder of said DMA mapping space of said at least one device adapter comprises at least DMA mapping space for data.

5. A method for mapping DMA mapping space of a plurality of adapters of a communication system, said adapters configured to communicate with respect to a computer processor memory structure of said communication system via DMA, said DMA mapping space for control information and data, comprising the steps of:
initiating an IML of said communication system;
separating said plurality of adapters into at least two groups;
separating control information DMA mapping of said computer processor memory structure for said adapters into at least three types: type “H” mapping, type “D” mapping, and shared mapping;
allocating DMA memory space of said DMA mapping space to each of said plurality of adapters; and
applying said type “H” mapping and said shared mapping to one of said groups of adapters for said DMA mapping space for control information, and applying said type “D” mapping and said shared mapping to another of said groups of adapters for said DMA mapping space for control information, and overlaying said type “H” mapping of said one of said groups of adapters and said type “D” mapping of said another of said groups of adapters in said DMA mapping space for control information of said respective adapters.

6. The method of claim 5, wherein said groups of adapters comprise at least one host adapter comprising said one group and at least one device adapter comprising said another group, and said step of applying said mapping comprises applying said type “H” mapping and said shared mapping to said at least one host adapter for said DMA mapping space, and applying said type “D” mapping and said shared mapping to said at least one device adapter for said DMA mapping space, overlaying said type “H” mapping of said at least one host adapter and said type “D” mapping of said at least one device adapter in said DMA mapping space.

7. The method of claim 6, wherein the remainder of said DMA mapping space of said at least one host adapter comprises at least DMA mapping space for data.

8. The method of claim 6, wherein the remainder of said DMA mapping space of said at least one device adapter comprises at least DMA mapping space for data.
